(19) United States
(12) Patent Application Publication
(10) Pub. No.: US 2024/0255837 A1
(43) Pub. Date: Aug. 1, 2024

(54) PROJECTION APPARATUS

(71) Applicant: Coretronic Corporation, Hsin-Chu (TW)

(72) Inventors: Wen-Yen Chung, Hsin-Chu (TW); Tung-Chou Hu, Hsin-Chu (TW); Fan-Chieh Chang, Hsin-Chu (TW)

(73) Assignee: Coretronic Corporation, Hsin-Chu (TW)

(21) Appl. No.: 18/426,352

(22) Filed: Jan. 30, 2024

(30) Foreign Application Priority Data
Jan. 30, 2023 (CN) 202310044567.8

(51) Int. Cl. G03B 21/16

(52) U.S. Cl. CPC G03B 21/16

(57) ABSTRACT

A projection apparatus includes an illumination system; an optical engine module; a lens module; and a heat-dissipation module. The illumination system includes a light source, and is configured to provide an illumination light beam. The optical engine module includes a light valve. The light valve is disposed on a transmission path of the illumination light beam, and configured to convert the illumination light beam into an image light beam. The lens module is disposed on a transmission path of the image light beam, and configured to project the image light beam out of the projection apparatus. The lens module has an optical axis. The lens module is adapted to move between a first position and a second position along the optical axis. The heat-dissipation module includes a heat dissipating device, a first liquid-cooling plate, a second liquid-cooling plate, and a plurality of pipes. The first liquid-cooling plate is connected to the light source. The second liquid-cooling plate is connected to the light valve. The heat dissipating device, the first liquid-cooling plate, and the second liquid-cooling plate are connected to each other via the plurality of pipes and form a loop to circularly dissipate heat from the light source and the light valve. When the lens module moves, the light source, the first liquid-cooling plate, the light valve, and the second liquid-cooling plate move together with the lens module.

### CROSS-REFERENCE TO RELATED APPLICATION

This application claims the priority benefit of Chinese application no. 202310044567.8, filed on Jan. 30, 2023. The entirety of the above-mentioned patent application is hereby incorporated by reference herein and made a part of this specification.

### BACKGROUND

### Technical Field

The disclosure relates to an optical device. Particularly, the disclosure relates to a projection apparatus.

### Description of Related Art

At present, since an ultra-short-throw projection apparatus provides only a fixed projection size, the flexibility and versatility of use of the ultra-short-throw projection apparatus are greatly reduced. To achieve the purpose that the ultra-short-throw projection apparatus moves projection, it is required that a light valve and a light source can be moved by the same distance as the lens does. However, this approach leads to a heat-dissipation module of the light valve and a heat-dissipation module of the light source not able to effectively dissipate heat from the light valve and the light source, reducing the overall heat dissipation effect of the ultra-short-throw projection apparatus, and affecting the projection quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection apparatus, which moves projection to adjust a size and a focal length of a projection screen, and has a better heat dissipation effect.

Other purposes and advantages of the disclosure may be further understood from the technical features of the disclosure.

To achieve one, some, or all of the above purposes or other purposes, an embodiment of the disclosure provides a projection apparatus, including an illumination system, an optical engine module, a lens module, and a heat-dissipation module. The illumination system includes a light source, and is configured to provide an illumination light beam. The optical engine module includes a light valve. The light valve is disposed on a transmission path of the illumination light beam, and configured to convert the illumination light beam into an image light beam. The lens module is disposed on a transmission path of the image light beam, and configured to project the image light beam out of the projection apparatus. The lens module has an optical axis, and the lens module is adapted to move between a first position and a second position along the optical axis. The heat-dissipation module includes a heat dissipating device, a first liquid-cooling plate, a second liquid-cooling plate, and a plurality of pipes. The first liquid-cooling plate is connected to the light source. The second liquid-cooling plate is connected to the light valve. The heat dissipating device, the first liquid-cooling plate, and the second liquid-cooling plate are connected to each other via the plurality of pipes and form a loop to circularly dissipate heat from the light source and the light valve. When the lens module moves, the light source, the first liquid-cooling plate, the light valve, and the second liquid-cooling plate move together with the lens module.

In an embodiment of the disclosure, a geometric center of the optical engine module is located at a first reference plane, and the first reference plane divides the projection apparatus into an upper region and a lower region. At least a part of the optical engine module and at least a part of the lens module are located at the upper region. The heat-dissipation module is located at the lower region of the projection apparatus.

In an embodiment of the disclosure, the projection apparatus further includes a heat-dissipation fan, disposed at the lower region of the projection apparatus and adjacent to the heat dissipating device.

In an embodiment of the disclosure, the projection apparatus further includes a system fan, disposed at the lower region of the projection apparatus. The heat-dissipation fan and the system fan are located at a left side and a right side of the optical engine module.

In an embodiment of the disclosure, the projection apparatus further includes a power supplier and a circuit board. The power supplier is disposed at the lower region of the projection apparatus. The circuit board is disposed at the lower region of the projection apparatus. When the lens module moves, the power supplier and the circuit board do not move together with the lens module.

In an embodiment of the disclosure, a second reference plane is perpendicular to the first reference plane, and is located at one side of the illumination system. An outermost side of the heat-dissipation module does not exceed the second reference plane.

In an embodiment of the disclosure, the heat-dissipation module further includes an accommodating tank and a driving element. The accommodating tank is connected to the plurality of pipes, and the accommodating tank is configured to accommodate a liquid medium. The driving element is connected to the plurality of pipes. The liquid medium in the accommodating tank is transferred to the plurality of pipes through the driving element.

In an embodiment of the disclosure, the plurality of pipes include a first deformable pipe. The first deformable pipe is connected between one of the first liquid-cooling plate and the second liquid-cooling plate and one of the heat dissipating device, the driving element, and the accommodating tank. When the lens module moves, the heat dissipating device does not move together with the lens module.

In an embodiment of the disclosure, the plurality of pipes further include a second deformable pipe. The second deformable pipe is connected between the other one of the first liquid-cooling plate and the second liquid-cooling plate and another one of the heat dissipating device, the driving element, and the accommodating tank. When the lens module moves, the accommodating tank and the driving element do not move together with the lens module.

In an embodiment of the disclosure, when the lens module moves from the first position to the second position, states of the first deformable pipe and the second deformable pipe are changed.

In an embodiment of the disclosure, the plurality of pipes include a first deformable pipe and a second deformable pipe. The first deformable pipe is connected between one of the first liquid-cooling plate, the second liquid-cooling plate, the accommodating tank, and the driving element and the heat dissipating device. The second deformable pipe is connected between another one of the first liquid-cooling plate, the second liquid-cooling plate, the accommodating tank, and the driving element and the heat dissipating device. When the lens module moves, the accommodating tank and the driving element move together with the lens module.

In an embodiment of the disclosure, the projection apparatus further includes an adjustment module, configured to drive the lens module to move. The adjustment module comprises a moving plate, and the lens module is disposed on the moving plate.

In an embodiment of the disclosure, the projection apparatus further includes a casing. The illumination system, the optical engine module, and the heat-dissipation module are located within the casing. When the lens module is located at the first position, the lens module is located within the casing. When the lens module is located at the second position, the lens module protrudes out of the casing.

Based on the foregoing, the embodiment of the disclosure has at least one of the following advantages or effects. In the design of the projection apparatus of the embodiment of the disclosure, when the lens module moves, the light source, the first liquid-cooling plate connected to the light source, the light valve, and the second liquid-cooling plate connected to the light valve each move together with the lens module, such that the heat-dissipation module effectively dissipates heat from the light source and the light valve. Therefore, the projection apparatus of the embodiment of the disclosure has a better heat dissipation effect, and is able to provide a better display quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection apparatus according to an embodiment of the disclosure.

FIG. 2A is a schematic perspective view of the projection apparatus of FIG. 1.

FIG. 2B is a top view of the projection apparatus of FIG. 2A.

FIG. 2C is a left side view of the projection apparatus of FIG. 2A.

FIG. 2D is a bottom view of the projection apparatus of FIG. 2A.

FIG. 2E is a rear view of the projection apparatus of FIG. 2A.

FIG. 2F is a front view of the projection apparatus of FIG. 2A.

FIG. 2G is a top view of a lens module of the projection apparatus of FIG. 2A after being moved.

FIG. 2H is a left side view of the lens module of the projection apparatus of FIG. 2A after being moved.

FIG. 2I is a bottom view of the lens module of the projection apparatus of FIG. 2A after being moved.

FIG. 2J is a rear view of the lens module of the projection apparatus of FIG. 2A after being moved.

FIG. 2K is a front view of the lens module of the projection apparatus of FIG. 2A after being moved.

FIG. 3A is a top view of a projection apparatus according to another embodiment of the disclosure.

FIG. 3B is a left side view of the projection apparatus of FIG. 3A.

FIG. 3C is a rear view of the projection apparatus of FIG. 3A.

FIG. 3D is a top view of a lens module of the projection apparatus of FIG. 3A after being moved.

FIG. 3E is a left side view of the lens module of the projection apparatus of FIG. 3A after being moved.

FIG. 3F is a rear view of the lens module of the projection apparatus of FIG. 3A after being moved.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

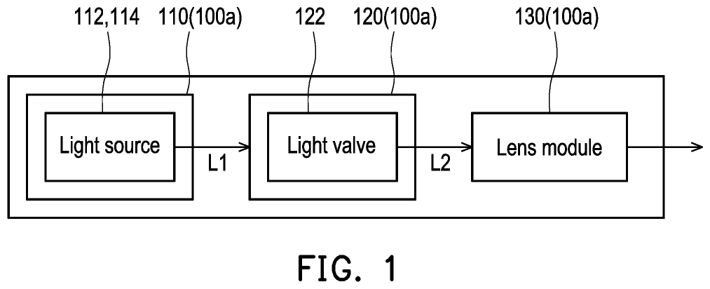

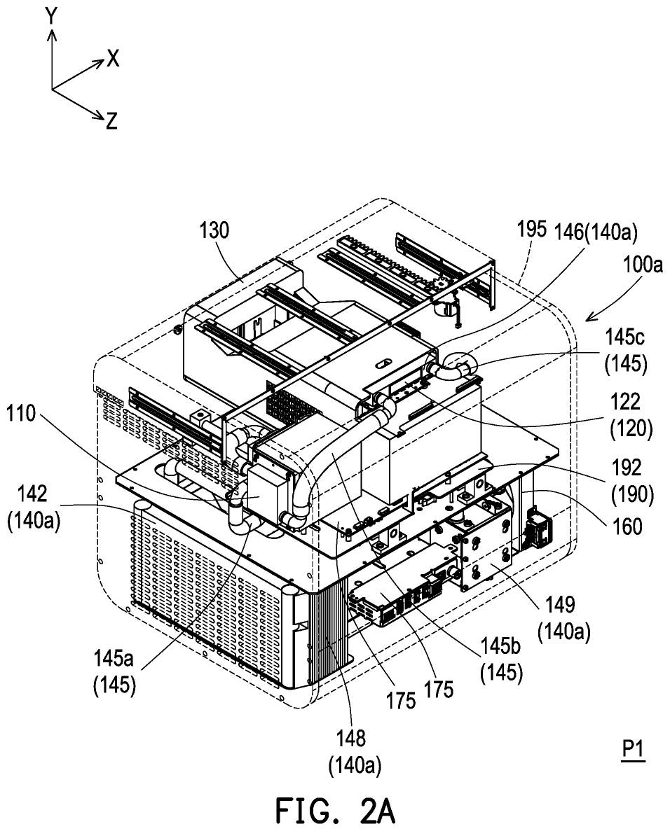

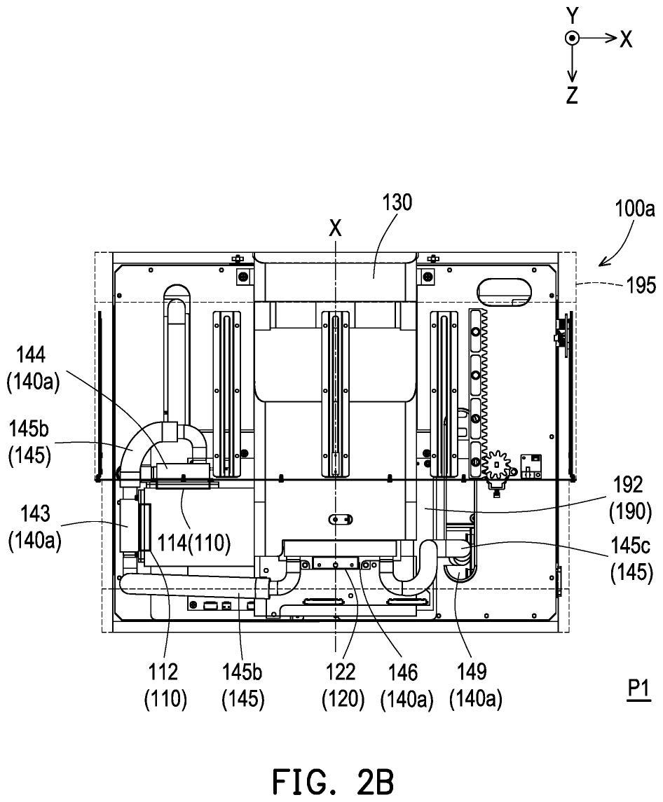

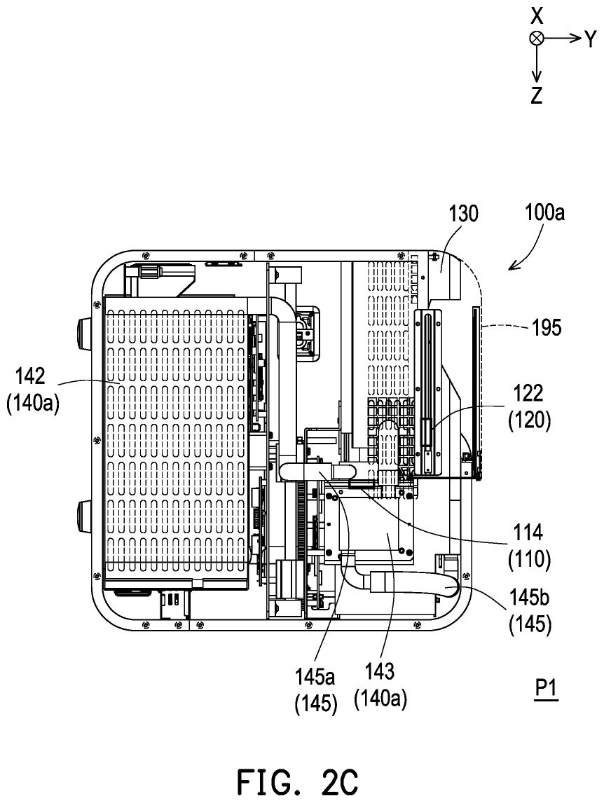

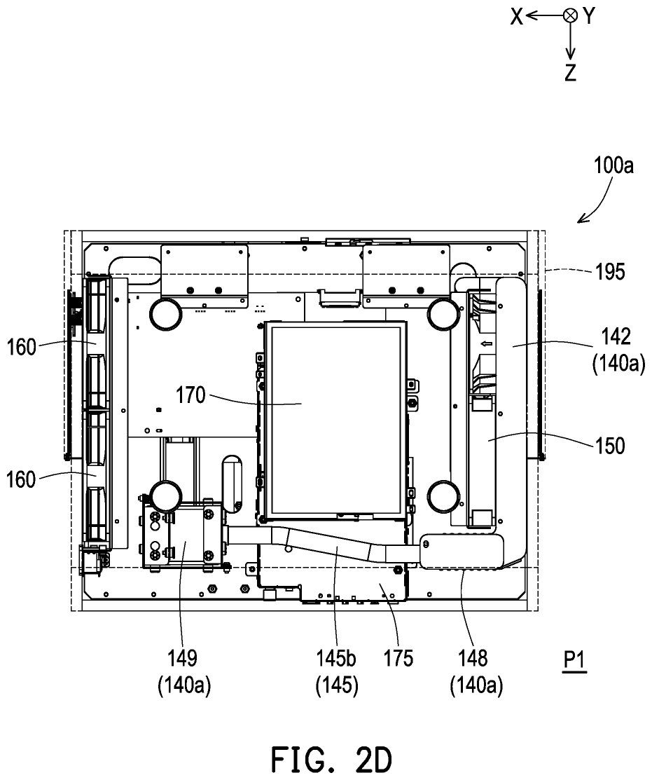

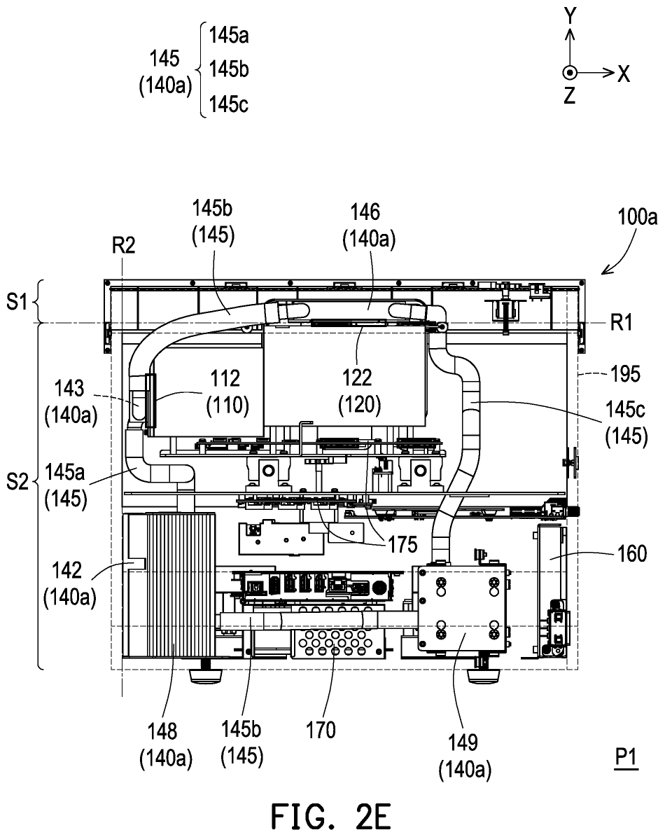

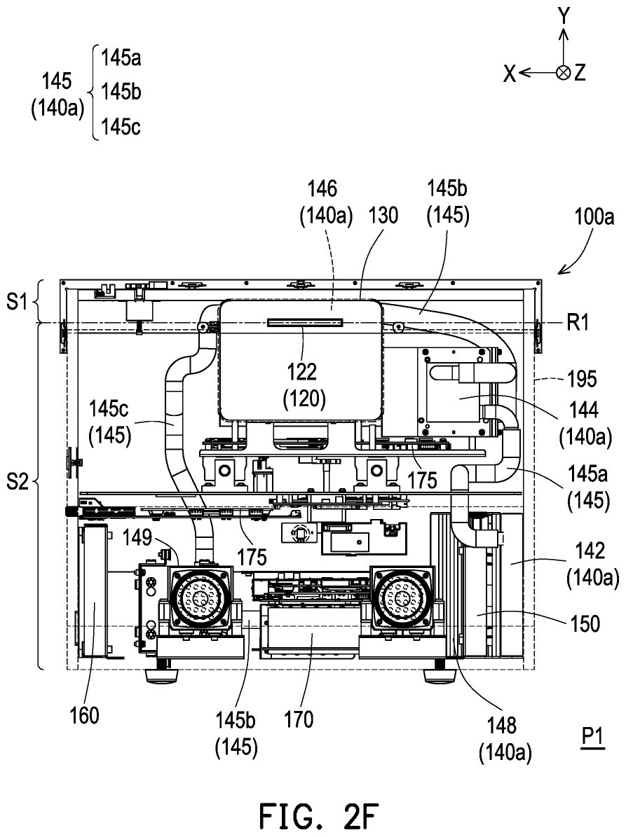

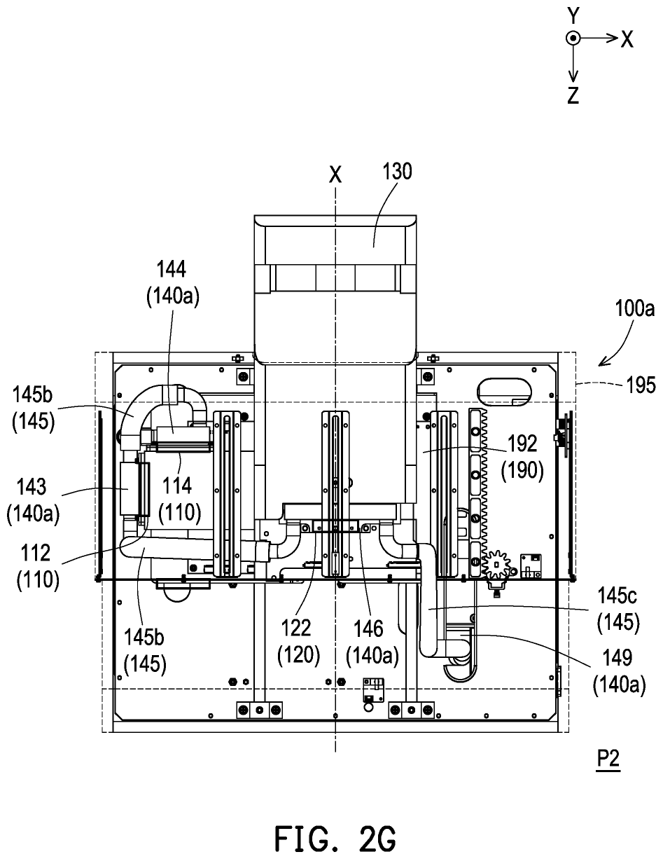

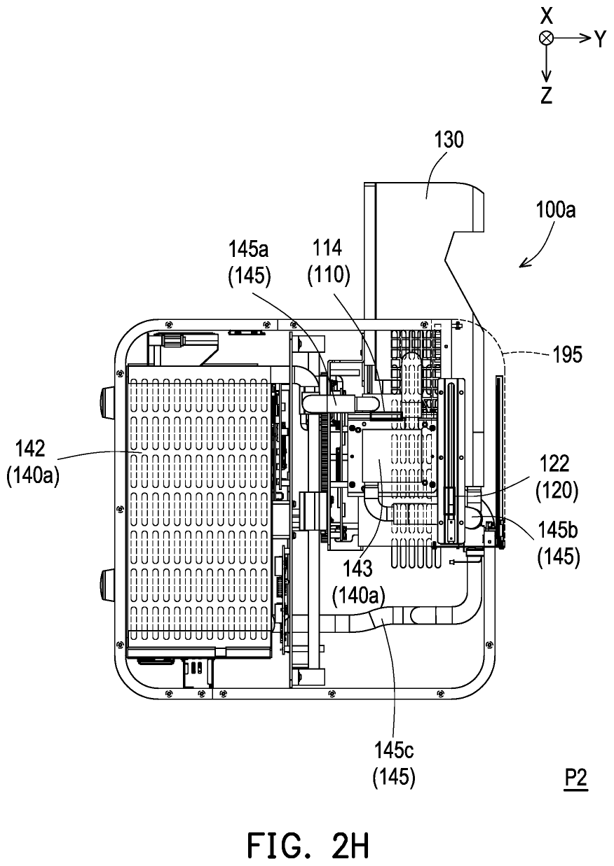

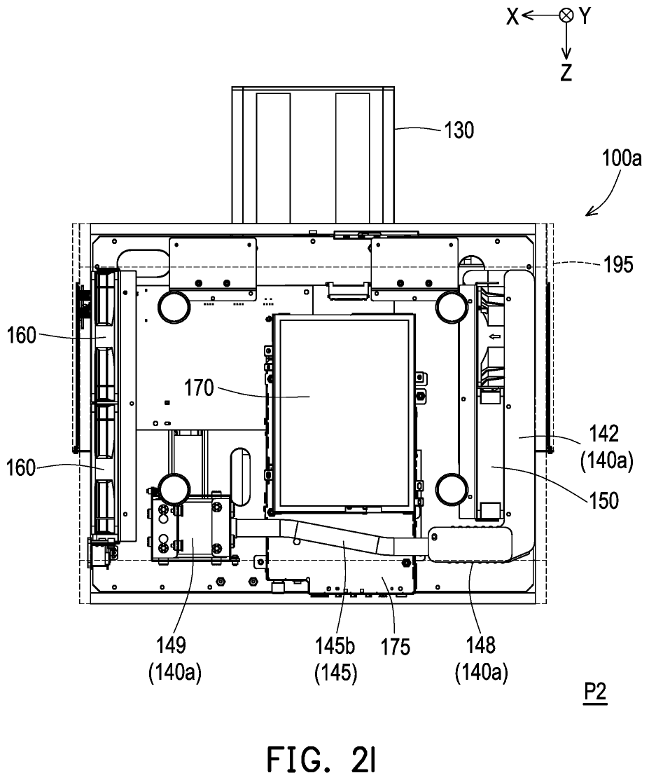

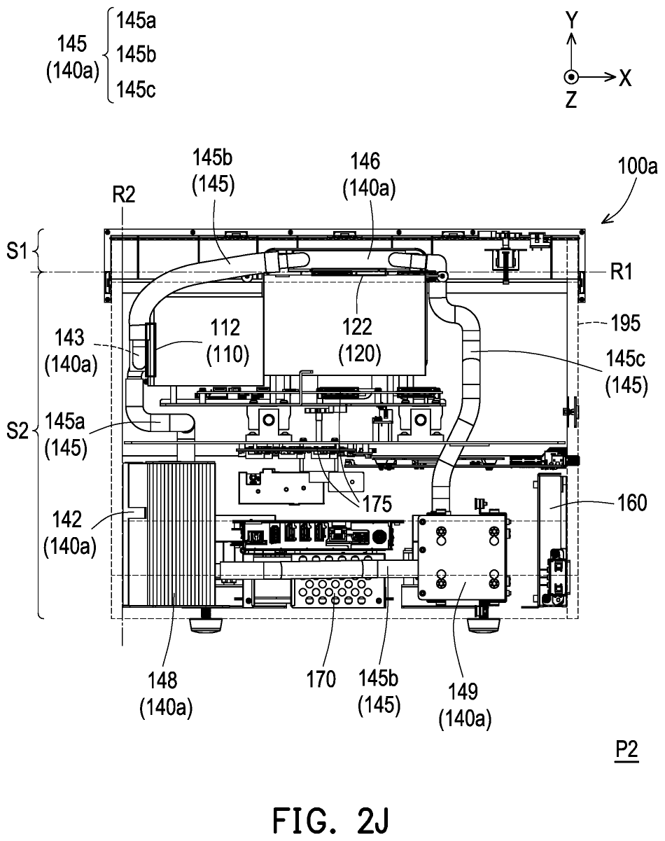

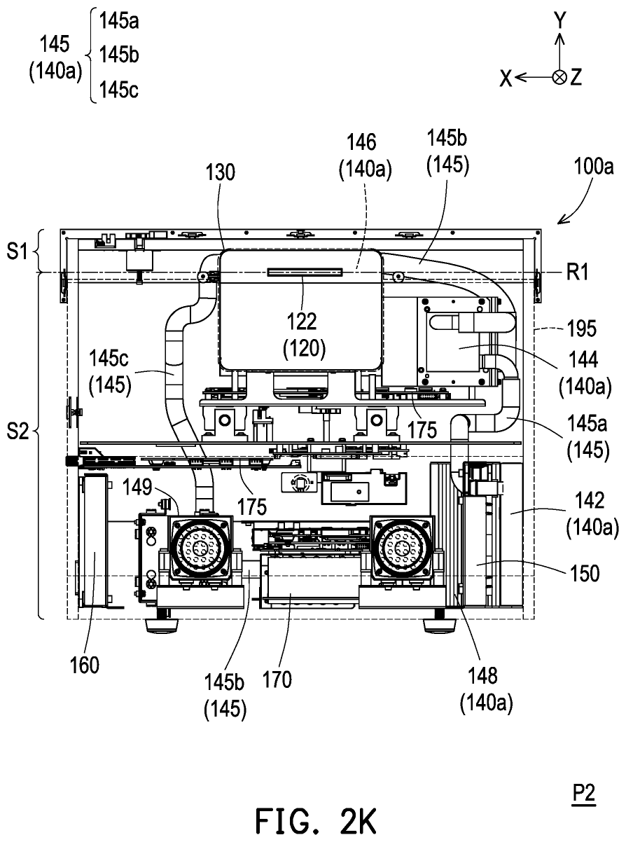

FIG. 1 is a schematic view of a projection apparatus according to an embodiment of the disclosure. FIG. 2A is a schematic perspective view of the projection apparatus of FIG. 1. FIG. 2B is a top view of the projection apparatus of FIG. 2A. FIG. 2C is a left side view of the projection apparatus of FIG. 2A. FIG. 2D is a bottom view of the projection apparatus of FIG. 2A. FIG. 2E is a rear view of the projection apparatus of FIG. 2A. FIG. 2F is a front view of the projection apparatus of FIG. 2A. FIG. 2G is a top view of a lens module of the projection apparatus of FIG. 2A after being moved. FIG. 2H is a left side view of the lens module of the projection apparatus of FIG. 2A after being moved. FIG. 2I is a bottom view of the lens module of the projection apparatus of FIG. 2A after being moved. FIG. 2J is a rear view of the lens module of the projection apparatus of FIG. 2A after being moved. FIG. 2K is a front view of the lens module of the projection apparatus of FIG. 2A after being moved. For clarity of description, a casing 195 in FIG. 2A to FIG. 2K is shown with broken lines.

First, referring to FIG. 1, FIG. 2A, and FIG. 2B, in this embodiment, a projection apparatus 100a includes an illumination system 110, an optical engine module 120, a lens module 130, and a heat-dissipation module 140a. The illumination system 110 includes light sources 112, 114, and is configured to provide an illumination light beam L1. The optical engine module 120 includes a light valve 122. The light valve 122 is disposed on a transmission path of the illumination light beam L1, and is configured to convert the illumination light beam L1 into an image light beam L2. The lens module 130 is disposed on a transmission path of the image light beam L2, and is configured to project the image light beam L2 out of the projection apparatus 100a.

In this embodiment, the light sources 112, 114 include an excitation light source. The excitation light source includes at least one light emitting diode (LED), at least one laser diode (LD), at least one LED array, at least one LD array, or a combination thereof, for example. The illumination system 110 may also include a wavelength conversion element, a light uniforming element, a filter element, and at least one light guide element. The illumination system 110 is configured to provide light beams of different wavelengths as a source of the illumination light beam L1. Specifically, light sources that the meet volume requirements in the actual design may each be implemented, and the type or form of the illumination system 110 is not specifically limited by the disclosure. The light valve 122 is a reflective-type light modulator, for example, a liquid crystal on silicon panel (LCoS panel) or a digital micro-mirror device (DMD). In an embodiment, the light valve 122 is a transmissive-type light modulator, for example, a transparent liquid crystal panel, an electro-optical modulator, a magneto-optic modulator, or an acousto-optic modulator (AOM). Nonetheless, the form and type of the light valve 122 are not limited by this embodiment. For the detailed steps and implementations of the way the light valve 122 converts the illumination light beam L1 into the image light beam L2, sufficient teachings, suggestions, and implementation descriptions may be obtained from common general knowledge in the related technical field, which are thus not repeatedly described here. The lens valve 130 includes, for example, one optical lens element or a combination of a plurality of optical lens elements having refractive power, for example, including various combinations of non-planar lens elements, such as a biconcave lens element, a biconvex lens element, a concavo-convex lens element, a convexo-concave lens element, a plano-convex lens element, and a plano-concave lens element. In an embodiment, the lens module 130 may also include a planar optical lens element, and projects the image light beam L2 from the optical engine module 120 out of the projection apparatus 100a by reflection or transmission. The lens module 130 of this embodiment is embodied as an ultra-short-throw lens.

Referring to FIG. 2B and FIG. 2G together, in this embodiment, the lens module 130 has an optical axis X. The lens module 130 is adapted to move between a first position P1 and a second position P2 along the optical axis X for adjusting the size of the projection screen and the focal length. Then, referring to FIG. 2B, FIG. 2C, FIG. 2D, FIG. 2E, and FIG. 2F, in this embodiment, the heat-dissipation module 140a includes a heat dissipating device 142, first liquid-cooling plates 143, 144, a second liquid-cooling plate 146, and a plurality of pipes 145. The first liquid-cooling plate 143 is connected to the light source 112, the first liquid-cooling plate 144 is connected to the light source 114, and the second liquid-cooling plate 146 is connected to the light valve 122. The heat dissipating device 142, the first liquid-cooling plates 143, 144, and the second liquid-cooling plate 146 are connected to each other via the plurality of pipes 145 and form a loop to circularly dissipate heat from the light sources 112, 114 and the light valve 122. It should be noted here that two light sources 112, 114 and two first liquid-cooling plates 143, 144 are taken as examples in this embodiment, while the numbers of light sources and first liquid-cooling plates are not specifically limited by this embodiment.

Next, referring to FIG. 2D, FIG. 2E, and FIG. 2F, in this embodiment, the heat-dissipation module 140a further includes an accommodating tank 148 and a driving element 149. The accommodating tank 148 is connected to the plurality of pipes 145, and the accommodating tank 148 is configured to store a liquid medium. The driving element 149 is connected to the plurality of pipes 145. The liquid medium in the accommodating tank 148 is conveyed to the plurality of pipes 145 through the driving element 149. The driving element 149 may be a pump, for example. Further, in this embodiment, the plurality of pipes 145 include a first deformable pipe 145a, a second deformable pipe 145c, and a plurality of fixed pipes 145b. The first deformable pipe 145a and the second deformable pipe 145c are each connected between a movable element and a non-movable element. The movable element includes the first liquid-cooling plates 143, 144 and the second liquid-cooling plate 146. The non-movable element includes the heat dissipating device 142, the driving element 149, and the accommodating tank 148. In other words, the first deformable pipe 145a is connected between one of the first liquid-cooling plates 143, 144 and the second liquid-cooling plate 146, and one of the heat dissipating device 142, the driving element 149, and the accommodating tank 148. The second deformable pipe 145c is connected between another one of the first liquid-cooling plates 143, 144 and the second liquid-cooling plate 146, and another one of the heat dissipating device 142, the driving element 149, and the accommodating tank 148. As embodied in this embodiment, as shown in FIG. 2F, the first deformable pipe 145a is connected between the first liquid-cooling plate 144 and the heat dissipating device 142, and as shown in FIG. 2E, the second deformable pipe 145c is connected between the second liquid-cooling plate 146 and the driving element 149. The plurality of fixed pipes 145b are connected between movable elements, or connected between non-movable elements. For example, the fixed pipe 145b is connected between the first liquid-cooling plate 144 and the second liquid-cooling plate 146. The fixed pipes 145b may also be connected between the accommodating tank 148 and the driving element 149, between the accommodating tank 148 and the heat dissipating device 142, and between the heat dissipating device 142 and the driving element 149, for example.

Referring to FIG. 2E and FIG. 2F together, in this embodiment, a geometric center of the optical engine module 120 is located on a first reference plane R1, and the first reference plane R1 divides projection apparatus 100a into an upper region S1 and a lower region S2. At least a part of the optical engine module 120 and at least a part of the lens module 130 are located at the upper region S1. At least a part of the heat-dissipation module 140a is located at the lower region S2 of the projection apparatus 100a. A second reference plane R2 is perpendicular to the first reference plane R1, and is located at one side of the illumination system 110. An outermost side of the heat-dissipation module 140a does not exceed the second reference plane R2. It should be noted here that FIG. 2E shows that the second reference plane R2 is located at the left side of the illumination system 110, and the left side of the heat-dissipation module 140a does not exceed the second reference plane R2. In other embodiments, if the illumination system 110 is located at the right side of the lens module 130, the second reference plane R2 is located at the right side of the illumination system 110, and the right side of the heat-dissipation module 140a does not exceed the second reference plane R2. To enhance heat dissipation efficiency, in this embodiment, the projection apparatus 100a further includes a heat-dissipation fan 150, disposed at the lower region S2 of the projection apparatus 100a and adjacent to the heat dissipating device 142. The projection apparatus 100a may further include a system fan 160, disposed at the lower region S2 of projection apparatus 100a. Here, as shown in FIG. 2F, on a reference plane perpendicular to the Z axis, the heat-dissipation fan 150 and the system fan 160 are respectively located at the right side and the left side of the optical engine module 120. In addition, the heat dissipating device 142 and the heat-dissipation fan 150 are located at the lower region S2 of the projection apparatus 100a, and thus may not affect the movement path of the lens module 130 located at the upper region S1 of the projection apparatus 100a. The lens module 130 can move for a maximum distance.

Furthermore, in this embodiment, the projection apparatus 100a further includes a power supplier 170 and a circuit board 175. The power supplier 170 and the circuit board 175 are disposed at the lower region S2 of the projection apparatus 100a. In addition, in this embodiment, the projection apparatus 100a further includes an adjustment module 190, configured to drive the lens module 130 to move. The adjustment module 190 includes a moving plate 192, and the lens module 130 is disposed on the moving plate 192. Moreover, in this embodiment, the projection apparatus 100a further includes a casing 195. The illumination system 110, the optical engine module 120, and the heat-dissipation module 140a are located within the casing 195.

Then, referring to FIG. 2B and FIG. 2G, when the lens module 130 is located at the first position P1, the lens module 130 is located within the casing 195; and when the lens module 130 is located at the second position P2, at least part of the lens module 130 protrudes out of the casing 195. Referring to FIG. 2B, FIG. 2C, FIG. 2D, FIG. 2E, FIG. 2F, FIG. 2G, FIG. 2H, FIG. 2I, FIG. 2J, and FIG. 2K, when the lens module 130 moves, for example, moves from the first position P1 to the second position P2, the light sources 112, 114, the first liquid-cooling plates 143, 144, the light valve 122, and the second liquid-cooling plate 146 move together with the lens module 130 to effectively dissipate heat from the light sources 112, 114 and the light valve 122. At this time, the heat dissipating device 142, the accommodating tank 148, the driving element 149, the power supplier 170, and the circuit board 175 do not move together with the lens module 130. In other words, positions of the heat dissipating device 142, the accommodating tank 148, the driving element 149, the power supplier 170, and the circuit board 175 are fixed and are not changed as the lens module 130 is moving.

Then, when the lens module 130 moves from the first position P1 to the second position P2, states of the first deformable pipe 145a and the second deformable pipe 145c are changed. For example, when the lens module 130 is located at the second position P2, the first deformable pipe 145a and the second deformable pipe 145c are in an extending state; and when the lens module 130 is located at the first position P1, the first deformable pipe 145a and the second deformable pipe 145c are in a bending state. Alternatively, when the lens module 130 is located at the first position P1, the first deformable pipe 145a and the second deformable pipe 145c are in an extending state; and when the lens module 130 is located at the second position P2, the first deformable pipe 145a and the second deformable pipe 145c are in a bending state. Due to the strong heat dissipation capability of water cooling, even if the pipes 145 are in a bending state, the heat dissipation requirements of the image screen presenting the maximum brightness may also be met.

During the circulation process of this embodiment, after the liquid medium (e.g., water) in the first liquid-cooling plates 143, 144 and the second liquid-cooling plate 146 is heated by the light sources 112, 114 and the light valve 122, the heated liquid medium flows to the heat dissipating device 142, exchanges heat with air from the outside through the heat-dissipation fan 150, generating a low-temperature liquid medium, then flows toward the accommodating tank 148, the driving element 149, and the first liquid-cooling plate 143, 144, and forms liquid-cooling circulation. In this water cooling system, the first liquid-cooling plate 143, 144, the second liquid-cooling plate 146, the light sources 112, 114, and the light valve 122 each move together with the lens module 130 to effectively dissipate the light sources 112, 114 and the light valve 122. Meanwhile, the accommodating tank 148, the driving element 149, the heat dissipating device 142, the heat-dissipation fan 150, and the system fan 160 do not move with the lens module 130, and remain unmoved.

In brief, in this embodiment, when the lens module 130 moves, the light sources 112, 114, the first liquid-cooling plates 143, 144 connected to light sources 112, 114, the light valve 122, and the second liquid-cooling plate 146 connected to the light valve 122 move together with the lens module 130, such that the heat-dissipation module 140a effectively dissipates heat from the light sources 112, 114 and the light valve 122. Therefore, in this embodiment, the projection apparatus 100a has a better heat dissipation effect, and is able to provide better display quality.

Other embodiments will be identified below for description. It should be noted here that the reference numerals and part of the contents of the above embodiments remain to be used in the following embodiments, where the same reference numerals are adopted to refer to the same or like elements, and descriptions of the same technical contents are omitted. Reference may be made to the above embodiments for the description of the omitted parts, which will not be repeated in the following embodiments.

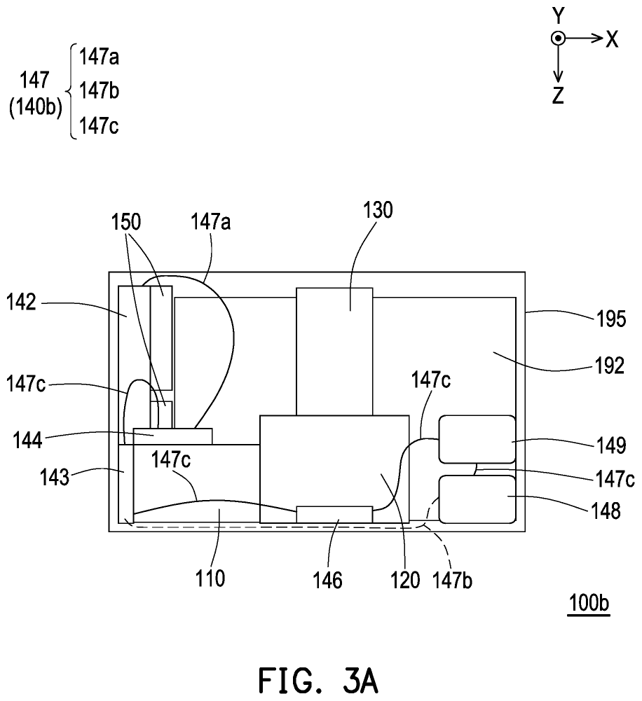

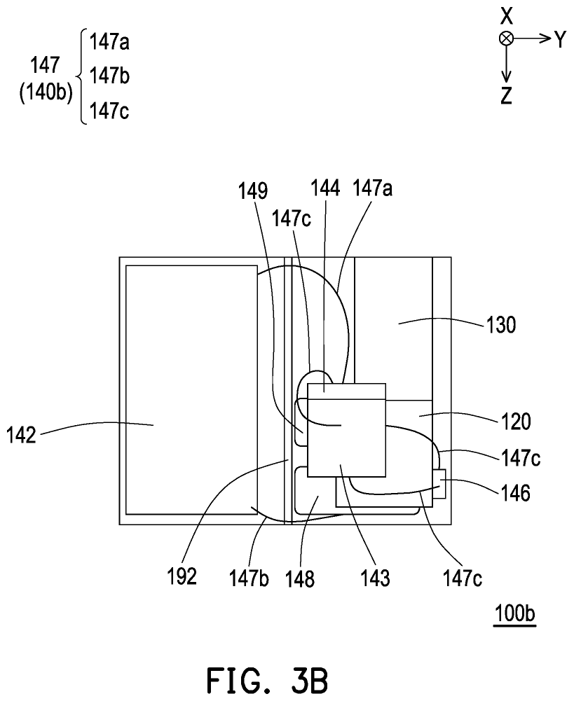

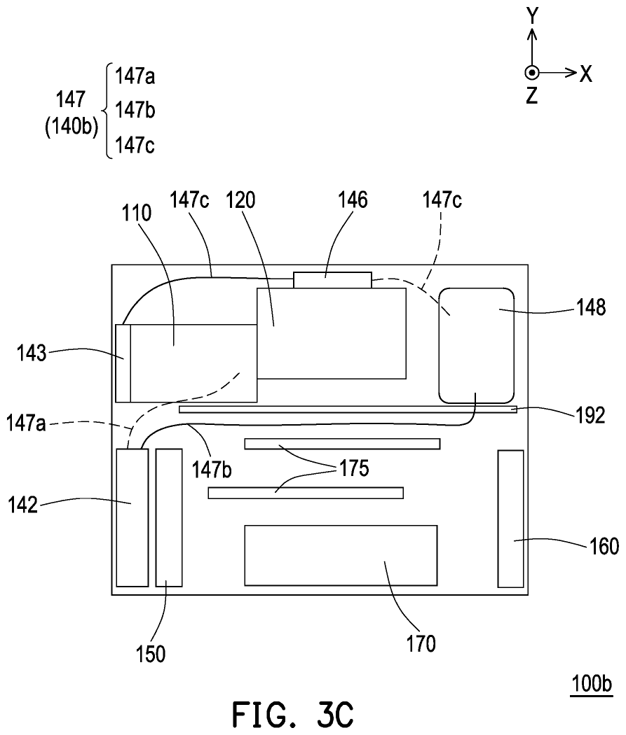

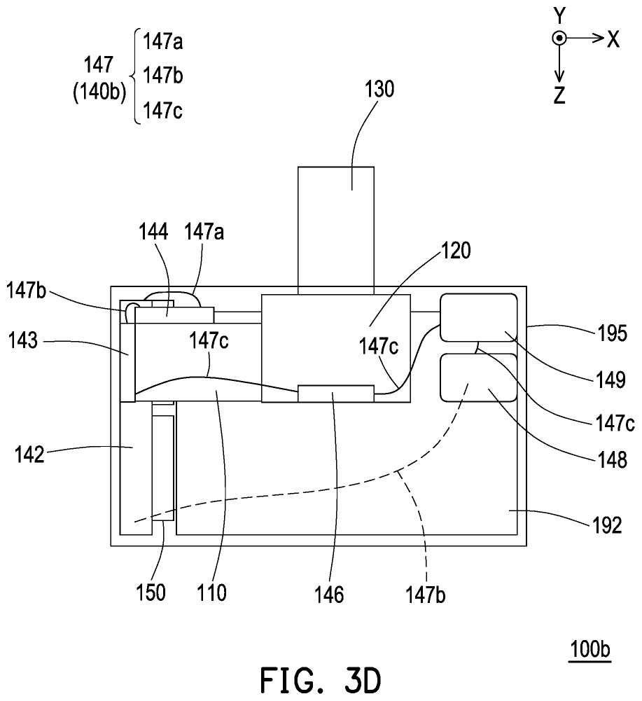

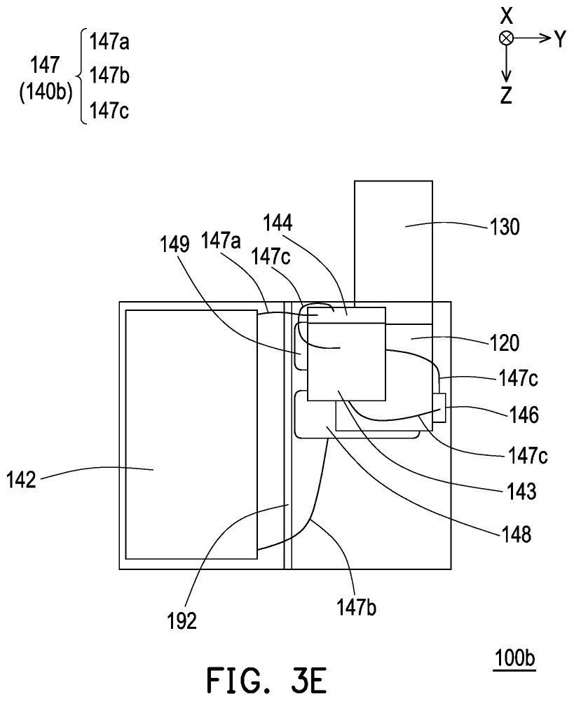

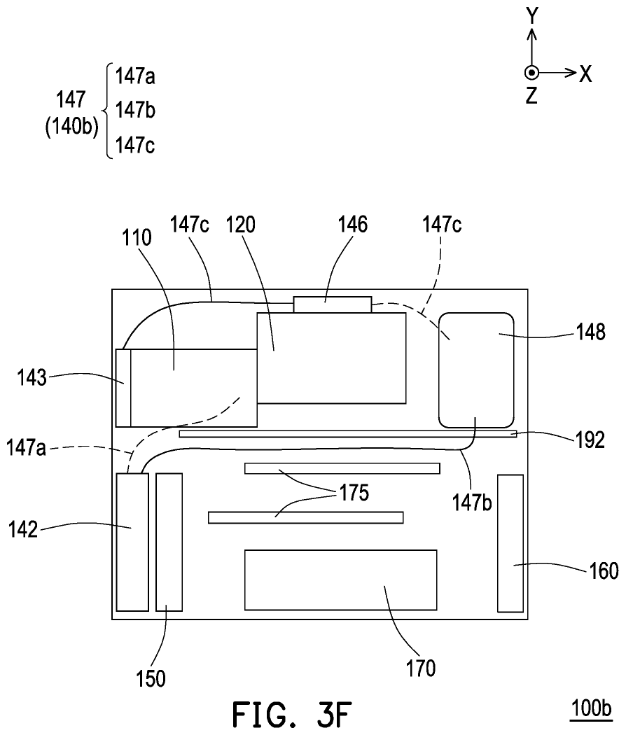

FIG. 3A is a top view of a projection apparatus according to another embodiment of the disclosure. FIG. 3B is a left side view of the projection apparatus of FIG. 3A. FIG. 3C is a rear view of the projection apparatus of FIG. 3A. FIG. 3D is a top view of a lens module of the projection apparatus of FIG. 3A after being moved. FIG. 3E is a left side view of the lens module of the projection apparatus of FIG. 3A after being moved. FIG. 3F is a rear view of the lens module of the projection apparatus of FIG. 3A after being moved.

First, referring to FIG. 2I, FIG. 2J, FIG. 3A, FIG. 3B, FIG. 3D, and FIG. 3F, a projection apparatus 100b of this embodiment is similar to the projection apparatus 100a in FIG. 2I, while the main differences between them lie in: in this embodiment, the accommodating tank 148 and the driving element 149 move together with the lens module 130.

To be specific, referring to FIG. 3A, FIG. 3B, FIG. 3C, FIG. 3D, FIG. 3E, and FIG. 3F together, in this embodiment, a plurality of pipes 147 of a heat-dissipation module 140b include a first deformable pipe 147a, a second deformable pipe 147b, and a fixed pipe 147c. The first deformable pipe 147a and the second deformable pipe 147b are connected between a movable element and a non-movable element. Here, the movable element includes the first liquid-cooling plates 143, 144, the second liquid-cooling plate 146, the accommodating tank 148, and the driving element 149; and the non-movable element includes the heat dissipating device 142. In other words, the first deformable pipe 147a may be connected between one of the first liquid-cooling plates 143, 144, the second liquid-cooling plate 146, the accommodating tank 148, and the driving element 149 and the heat dissipating device 142. The second deformable pipe 147b is connected between another one of the first liquid-cooling plates 143, 144, the second liquid-cooling plate 146, the accommodating tank 148, and the driving element 149 and the heat dissipating device 142.

Further, in this embodiment, as shown in FIG. 3A, the first deformable pipe 147a is connected between the first liquid-cooling plate 144 and the heat dissipating device 142, and as shown in FIG. 3C, the second deformable pipe 147b is connected between the accommodating tank 148 and the heat dissipating device 142. The fixed pipe 147c is connected between movable parts, for example, the fixed pipe 147c may be connected between the first liquid-cooling plate 143 and the first liquid-cooling plate 144, connected between the first liquid-cooling plates 143, 144 and the second liquid-cooling plate 146, connected between the second liquid-cooling plate 146 and the driving element 149, connected between the second liquid-cooling plate 146 and the accommodating tank 148, and connected between the accommodating tank 148 and the driving element 149. When the lens module 130 moves, the accommodating tank 148 and the driving element 149 move together with the lens module 130. In other words, in this embodiment, the first liquid-cooling plate 143, the second liquid-cooling plate 146, the light source 112, the light valve 122, the accommodating tank 148, and the driving element 149 move together with the lens module 130, while the heat dissipating device 142 is fixed.

In summary of the foregoing, the embodiment of the disclosure has at least one of the following advantages or effects. In the design of the projection apparatus of the embodiment of the disclosure, when the lens module moves, the light source, the first liquid-cooling plate connected to the light source, the light valve, and the second liquid-cooling plate connected to the light valve each move together with the lens module, such that the heat-dissipation module effectively dissipates heat from the light source and the light valve. Therefore, the projection apparatus of the embodiment of the disclosure has a better heat dissipation effect, providing better display quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
an illumination system, comprising a light source, and configured to provide an illumination light beam;
an optical engine module, comprising a light valve, wherein the light valve is disposed on a transmission path of the illumination light beam, and configured to convert the illumination light beam into an image light beam;
a lens module, disposed on a transmission path of the image light beam, and configured to project the image light beam out of the projection apparatus, wherein the lens module has an optical axis, and the lens module is adapted to move between a first position and a second position along the optical axis; and
a heat-dissipation module, comprising a heat dissipating device, a first liquid-cooling plate, a second liquid-cooling plate, and a plurality of pipes, wherein the first liquid-cooling plate is connected to the light source, the second liquid-cooling plate is connected to the light valve, the heat dissipating device, the first liquid-cooling plate, and the second liquid-cooling plate are connected to each other via the plurality of pipes and form a loop to circularly dissipate heat from the light source and the light valve, wherein when the lens module moves, the light source, the first liquid-cooling plate, the light valve, and the second liquid-cooling plate move together with the lens module.

2. The projection apparatus according to claim 1, wherein a geometric center of the optical engine module is located on a first reference plane, and the first reference plane divides the projection apparatus into an upper region and a lower region, at least a part of the optical engine module and at least a part of the lens module are located at the upper region, and the heat-dissipation module is located at the lower region of the projection apparatus.

3. The projection apparatus according to claim 2, further comprising:
a heat-dissipation fan, disposed at the lower region of the projection apparatus and adjacent to the heat dissipating device.

4. The projection apparatus according to claim 3, further comprising:
a system fan, disposed at the lower region of the projection apparatus, wherein the heat-dissipation fan and the system fan are located at a left side and a right side of the optical engine module.

5. The projection apparatus according to claim 2, further comprising:
a power supplier, disposed at the lower region of the projection apparatus; and
a circuit board, disposed at the lower region of the projection apparatus, wherein when the lens module moves, the power supplier and the circuit board do not move together with the lens module.

6. The projection apparatus according to claim 2, wherein a second reference plane is perpendicular to the first reference plane, and is located at one side of the illumination system, wherein an outermost side of the heat-dissipation module does not exceed the second reference plane.

7. The projection apparatus according to claim 1, wherein the heat-dissipation module further comprises:
an accommodating tank, connected to the plurality of pipes, the accommodating tank configured to accommodate a liquid medium; and
a driving element, connected to the plurality of pipes, wherein the liquid medium in the accommodating tank is conveyed to the plurality of pipes through the driving element.

8. The projection apparatus according to claim 7, wherein the plurality of pipes comprise a first deformable pipe, wherein the first deformable pipe is connected between one of the first liquid-cooling plate and the second liquid-cooling plate and one of the heat dissipating device, the driving element, and the accommodating tank, wherein when the lens module moves, the heat dissipating device does not move together with the lens module.

9. The projection apparatus according to claim 8, wherein the plurality of pipes further comprise a second deformable pipe, wherein the second deformable pipe is connected between the other one of the first liquid-cooling plate and the second liquid-cooling plate and another one of the heat dissipating device, the driving element, and the accommodating tank, wherein when the lens module moves, the accommodating tank and the driving element do not move together with the lens module.

10. The projection apparatus according to claim 9, wherein when the lens module moves from the first position to the second position, states of the first deformable pipe and the second deformable pipe are changed.

11. The projection apparatus according to claim 7, wherein the plurality of pipes comprise a first deformable pipe and a second deformable pipe, wherein the first deformable pipe is connected between one of the first liquid-cooling plate, the second liquid-cooling plate, the accommodating tank, and the driving element and the heat dissipating device, and the second deformable pipe is connected between another one of the first liquid-cooling plate, the second liquid-cooling plate, the accommodating tank, and the driving element and the heat dissipating device, wherein when the lens module moves, the accommodating tank and the driving element move together with the lens module.

12. The projection apparatus according to claim 11, further comprising:
an adjustment module, configured to drive the lens module to move, wherein the adjustment module comprises a moving plate, and the lens module is disposed on the moving plate.

13. The projection apparatus according to claim 1, further comprising:
a casing, wherein the illumination system, the optical engine module, and the heat-dissipation module are located within the casing, wherein when the lens module is located at the first position, the lens module is located within the casing, and when the lens module is located at the second position, the lens module protrudes out of the casing.
